(19) United States
(12) Patent Application Publication
(10) Pub. No.: US 2013/0300731 A1
(43) Pub. Date: Nov. 14, 2013

(54) METHOD FOR VISUALIZING A USER OF A VIRTUAL ENVIRONMENT

(71) Applicants: Sigurd Van Broeck, Zoersel (BE); Marc Van Den Broeck, Sint-Katelijne-Waver (BE); Zhe Lou, Mortsel (BE)

(72) Inventors: Sigurd Van Broeck, Zoersel (BE); Marc Van Den Broeck, Sint-Katelijne-Waver (BE); Zhe Lou, Mortsel (BE)

(73) Assignee: ALCATEL LUCENT, Paris (FR)

(21) Appl. No.: 13/811,514

(22) PCT Filed: Jul. 23, 2010
(86) PCT No.: PCT/IB10/01847

§ 371 Date: Mar. 27, 2013

(51) Int. Cl. G06T 13/40

(52) U.S. Cl. CPC G06T 13/40
USPC 345/419

(57) ABSTRACT

The present invention relates to a method, a related system and a related processing device for visualizing a user of a virtual environment in the virtual environment. The method of the present invention includes the step of generating a 3-dimensional user depth representation of the user to be visualized, based on at least one generated video stream of the user. In addition a texture of the user is determined based on the at least one generated video stream of the user. A subsequent step is generating a 3-dimensional user visualization by applying said texture onto said user depth representation and parenting said 3-dimensional user visualization onto a 3-dimensional host visualization.

The present invention relates to a Method, a system and related processing device for visualizing a user of a virtual environment in this virtual environment.

Such a method, system and related device are well known in the art from the currently well known ways of communicating through virtual environments (e.g. second life). In such virtual Environments, avatars can navigate (like walking, running, flying, teleporting, etc), take a pause to sit on a bench, talk to another avatar, or interact with other models (click or move objects, bump into a walls or other models, etc). Such Avatars often are comic styled 3-Dimensional models that can be animated by keyboard, mouse of other interaction devices or gestures and that can be observed by other avatars at any time from any direction. Such a virtual world may be a well suited environment for gaming and first contacts with other people.

Users of such a Virtual environment however do not prefer to be presented by an avatar when they immerge themselves in a virtual environment and they do not want to manipulate input devices to animate the avatar when communicating via a computer system to others like their relatives or buddies.

Such avatars are not perceived as good replacements for the real thing, i.e. people prefer the streaming video image of themselves inside such a virtual environment where there is no need for animations like smiling via some kind of input device.

An average user prefers to see the streaming images of the other users inside such virtual environments, at the same time be able to navigate within and interact with that virtual environment and furthermore interact with each other at the same time.

Most of the users of such a virtual environment are seated behind a Personal Computer or in an easy seat in front of a Television set when one is communicating to others like family and/or buddies. Therefore, such a user being captured by one or more cameras positioned at a desk or in front of the user cannot be captured in full but only respectively the upper front part or the entire front part of the person can be captured as streaming video output.

As said, streaming images captured by one or more cameras of people sitting behind their Personal Computer at a desk or in front of a Television set do not contain sufficient information to create a full 3D user visualiation since only the front side of the person is captured or only the upper part in case the person is sitting at a desk. In other words, the camera's are, due to the positioning of such camera(s) relative to the user to be captured, only able to capture about one quarter of the person, i.e the front part or the upper front part.

Hence there is no image information on the backside, the bottomside, the topside and on both left and right flank of the user available. Streaming images of the incomplete user representation, generated based on the output of the camera(s) are referred to as Q-Humans.

Hence no full 3D view is obtainable from this captured videostream due to the position of this user relative to the camera from which perspective not all of this user is visible. This partial 3D user visualization obviously is not directly suitable to be inserted into a Virtual Environment. For example, since there is no image-information on the backside of the person, other persons will see a concave image of the back of the person when walking behind the partial 3D user visualization inside the virtual environment. As no information on the backside, rights or left flank of the user is available and no presentation can be shown in such a virtual Environment.

An objective of the present invention is to provide a method for visualizing a user of such a virtual environment of the above known type but wherein virtually a full user visualization is obtained.

According to the invention, this objective is achieved by the method described in claim 1, the system defined in claim 3 and related devices as described in claim 5 and claim 7.

Indeed, according to the invention, this objective is achieved due to the fact that only a full 3-Dimensional user visualization is generated by coupling the first generated partial real-time 3-Dimensional user visualization with a 3-Dimensional host visualization in such way a full 3D user visualization of the user is realised.

This coupling can be achieved by parenting the first generated partial real-time 3-Dimensional user visualization onto a 3-Dimensional host visualization or coupling alternative may be done by logic such that the 3D user visualization tracks the position of the 3D host visualization and adapts its own position accordingly.

In this way the missing information on the backside, bottom, top right and left flanks of the generated partial real-time 3-Dimensional user visualization is completed or hidden by parenting this generated partial real-time 3-Dimensional user visualization onto the 3-Dimensional host visualization (model).

In an alternative way the missing information on the backside of the generated partial real-time 3-Dimensional user visualization is completed by means of a secondary plane, by stitching the right border of the model to the left border, or by any other means while the bottom, top, right and left flanks are left unchanged.

Such 3-Dimensional Host visualization may be any three dimensional model whereon the before generated partial real-time 3-Dimensional user visualization can be parented, further referred to as Q-Hosts.

Parenting is a process of putting objects in a certain hierarchy. The top node is referred to as the parent, where the parent is the 3-Dimensional host visualization in the present invention and the subsequent nodes are the children, where the generated partial real-time 3-Dimensional user visualization of the present invention is a child, that belong to this parent In a parented relationship, children can be moved/rotated anywhere in 3D space with no effect whatsoever on the parent node, however if the parent node is moved or rotated in 3D space, all it's children will move accordingly.

An example of such a 3-Dimensional Host visualization could be a hovering chair in which the generated partial 3-Dimensional user visualization is seated. In this way the backside of the 3-Dimensional user visualization is hidden by modelled backside, flanks, upper side and top side of the 3-Dimensional Host visualization. The partial real-time 3-Dimensional user visualization then is parented (on)to 3-Dimensional host visualization, so when we move the 3-Dimensional host visualization, the 3-Dimensional user visualization comes along.

Another example could be that we represent the 3-Dimensional Host visualization as a full 3D representation of a Human. By using an intelligent stitching algorithm we could stitch the generated partial 3-Dimensional user visualization to the 3-Dimensional host visualization. In this way a 3D model is obtained, wherein the upper front side of the body is composed of a real life 3D video stream and the other parts have a more synthetic look and feel.

Another characterizing embodiment of the present invention is described in claim 2, claim 4 and claim 6.

The method, the related system and related processing device still can be improved by performing the step of coupling, like parenting, in such way that the real-time generated partial 3-dimensional user visualization at least partly is covered by the 3-dimensional host visualization. In this way the generated partial 3 dimensional user visualization will partly disappear in, or stitched to the 3-dimensional host visualization in order to simplify the 3-dimensional user visualization and furthermore, this feature will dismiss the need to cut the plane along the contours of the person extracted from the streaming video. Hence by using displacement maps, the original, often rectangular plane onto which the displacement map is projected can be hidden inside the 3-dimensional host visualization.

It is to be noticed that the term ‘comprising’, used in the claims, should not be interpreted as being restricted to the means listed thereafter. Thus, the scope of the expression ‘a device comprising means A and B’ should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

The above and other objects and features of the invention will become more apparent and the invention itself will be best understood by referring to the following description of an embodiment taken in conjunction with the accompanying drawings wherein:

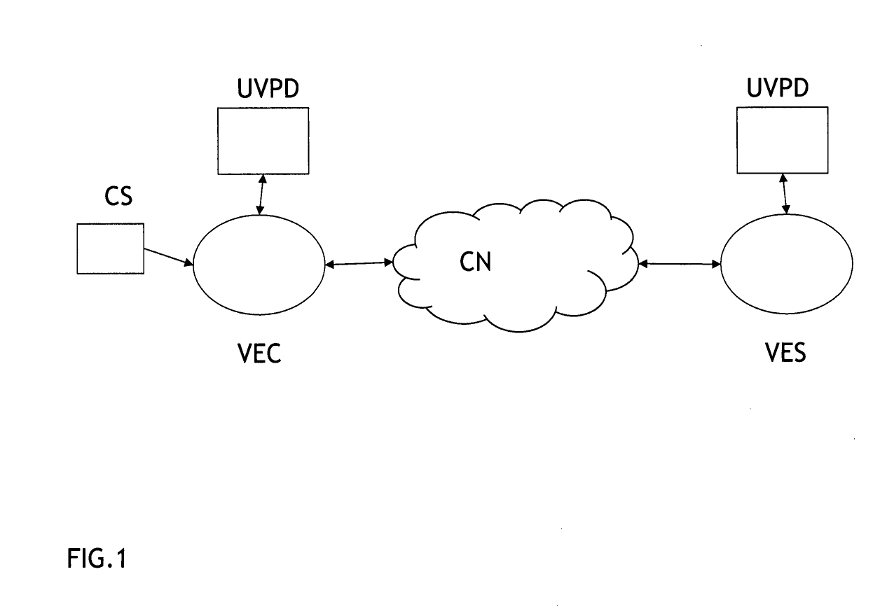

FIG. 1 represents the functional representation of a system for visualizing a user of a virtual environment in this virtual environment according to the present invention.

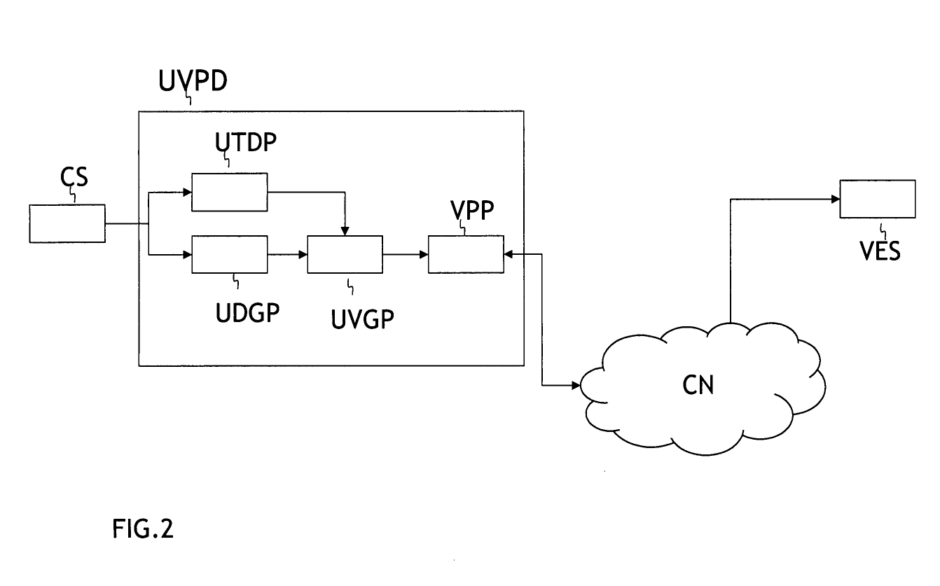

FIG. 2 represents the functional representation of the system with a detailed functional representation of the User Visualization processing device according to the present invention

In the first paragraph of this description the main elements of the system for visualizing a user of a virtual environment in this virtual environment as presented in FIG. 1 are described. In the second paragraph, all connections between the before mentioned elements and described means are defined. Subsequently all relevant functional means of the user visualization processing device UVPD, the camera system CS and the virtual environment VE are described followed by a description of all interconnections. In the succeeding paragraph the actual execution of the method for browsing content related to an object is described.

The first main element of the present invention is the camera system CS that may be embodied by a camera system that can provide depth information. In a first embodiment of such a camera system dedicated depth-camera is applied. In this case more specifically the Z-Cam from 3DVSystems may be used where such a camera provides with a series of black and white depth images and their corresponding colored texture image.

In a second, alternative, embodiment of such a camera system, two synchronized cameras in combination with an algorithm are applied to calculate the depth from the differences between two images taken at the same timeslot. This is done by a process called disparity mapping. Both camera's produce an image. So for each point in image 1 the corresponding location of the same pixel is computed in image 2. Once the corresponding pixels have been found, a disparity of all these points is calculated. The end result is a disparity map which gives us an indication of where these points reside in 3D space.

In a third alternative, structure light is used to derive the depth from the scene. In this configuration, a projector or a set of synchronized projectors send varying patterns of light onto the real environment while capturing the environment with two or more synchronized cameras. By comparing the patterns in the captured images from the different cameras over space and time, an indication of the depth of the scene can be derived.

Further there may be a virtual environment client device VEC executing a client application for accessing a 3-Dimensional Virtual environment.

In addition there may be a User Visualization Processing device UVPD that is able to generate from the camera system output, a 3-dimensional user depth representation being a displacement map of a user to be visualized in the virtual environment and a texture of the user. Subsequently the User Visualization Processing device UVPD is adapted to generate a 3-dimensional user visualization by applying the texture onto the 3-dimensional user depth generation. Finally, a full 3-dimensional user visualization is obtainable by parenting the generated partial 3-dimensional user visualization onto a 3-dimensional host visualization.

The full 3-dimensional user visualization is fed into the Virtual Environment as a full representation of the user in this Virtual Environment VE.

The Camera system CS is coupled to the User Visualization Processing device UVPD over any short communications interface like Ethernet, USB, IP, Firewire etc. to a client device accessing and communicating with a Virtual Environment server VES hosting or giving access to a Virtual environment. The client device may be coupled to the Virtual Environment server VES over a communications network like the internet or any combination of access networks and core networks.

The User Visualization Processing device UVPD first comprises a user depth generating part UDGP that is adapted to generate a 3-dimensional user depth representation, e.g. being displacement map of the user to be visualized, based on camera system signal e.g. being at least two generated video streams of the user.

Furthermore, the User Visualization Processing device UVPD includes a texture determination part UTDP that is able to determine a texture of the user from the provided camera system signal, i.e. the moving pictures recorded by the camera.

The Visualization Processing device UVPD further comprises a User visualization generating part UVGP for generating a partial 3-dimensional user visualization by applying the texture onto the generated partial 3-dimensional user depth generation and a Visualization parenting part VPP that is, adapted to generate a full 3-dimensional user visualization by parenting said generated partial 3-dimensional user visualization onto a 3-dimensional host visualization.

It is here to be mentioned that in case of applying a Z-cam as previously mentioned, the user depth generating part UDGP is incorporated in the Z-cam device.

Additionally the visualization parenting part VPP is able to perform the parenting in such way that said user visualization partly is covered by said host visualization.

The User Visualization Processing device UVPD has an input-terminal that is at the same time an input-terminal of the user depth generating part UDGP and an input-terminal of the user texture determination part UTDP. The user texture determination part UTDP further is coupled with an output-terminal to an input-terminal of the User visualization generating part UVGP. The user depth generating part UDGP further is coupled with an output-terminal to an input-terminal of the User visualization generating part UVGP. The User visualization generating part UVGP in turn is coupled with an output-terminal to an input-terminal of the visualization parenting part VPP that in turn has an output-terminal of the User Visualization Processing device UVPD.

Although this description deals with a User Visualization Processing device UVPD with functionality that is central, the entire functionality may be distributed over several network elements like client and server in the former description.

Finally there is a Virtual environment server VES that hosts the Virtual Environment. Although usually a plurality of such servers is present for hosting such a Virtual Environment, in this embodiment for clarity reasons only one such server is described and presented in FIG. 1.

In order to explain the operation of the present invention it is assumed that a certain user of a virtual environment such as Second life is wandering through Second life. This user being seated in front of his desk and personal computer browsing through Second Life. In this position of the Virtual Environment user it is not possible to produce, with a camera positioned on the desk, streaming images of the entire user while he is sitting behind the Personal Computer, as these images do not contain sufficient information to create a full avatar model with a 360 degrees view.

Instead, it is only possible as in most cases, only the front side of the person is captured and only the upper part in case the person is sitting at a desk, to generate a 3-dimensional model of the upper frontal part of the person.

To improve this situation and achieve the objectives of the present invention, a camera such as the z-cam is mounted in a suitable way on the user's desk. The camera will capture the texture and the depth image. In case of a minoru stereocam the depth image is generated by means of the user depth generating part UDGP.

In order to have suitable representation of his own person in this virtual environment, such as Second Life, the camera system sends this texture image and its corresponding depth image in real time towards the User Visualization Processing device UVPD. This signal still only contains information on the upper part of the user, i.e. the part of the user above the desk being the torso and head. This User Visualization Processing device UVPD may be a dedicated device coupled to the client device VEC or an application located at the client device, be located at the server side VES, or even be distributed over the network. Where the application is located at the client device it may be an application running on the user's personal computer.

First, the user depth generating part UDGP of the User Visualization Processing device UVPD generates a 3-dimensional user depth representation (displacement map) of this user based on the forwarded camera system signal e.g. being at least one generated stereo video stream or two generated mono video streams of said user. The forwarded camera system signal e.g. being at least one generated video stream of the user furthermore is used by the user texture determination part UTDP, for determining a texture of the user. In this case the texture of the user is the streaming images of the user which are recorded by the camera. Subsequently the User visualization generating part UVGP generates a partial 3-dimensional user visualization of the user by applying the, earlier, determined texture onto the 3-dimensional user depth generation (displacement map). Here, a partial 3-dimensional representation of the user results where only information on the frontal part of the torso and head of the user is included. Hence, the 3-dimensional model which is produced, nor includes information on the back part of the user neither can a 3-dimensional representation of the lower part of the body of the user be provided of the lower part of the body of the user.

Finally, the Visualization parenting part VPP generates a full 3-dimensional user visualization by parenting the 3-dimensional user visualization onto a 3-dimensional host visualization where the 3-dimensional host visualization may be any predefined 3-dimensional model where the said 3-dimensional user visualization can be combined with, so that the final obtained user representation is a 3-dimensional model with an 360 degrees view.

Such a 3-dimensional host may be any 3-D model like a hovering chair and where the characteristic of the hovering chair are such that it hides the back side of the person as well as the lower part.

The partial 3-dimensional user visualization or partial user's model are futher parented to the 3-dimensional host visualization in such way that they move along with the movements of the 3-dimensional host visualization as single unit 3-dimensional user visualization.

Other examples of such 3-dimensional host are a 3-Dimensional model of a human.

In order to simplify the model building the parenting can be performed in such way that the user visualization partly is covered by said host visualization.

In another embodiment, the 3-dimensional user visualization will partly disappear in the 3-dimensional host visualization with the objective to simplify the model creation of the 3-dimensional user visualization. Indeed, using displacement maps, the original, often rectangular plane onto which the displacement map is projected can be hidden inside the 3-dimensional host visualization. This feature will dismiss the need to cut the plane along the contours of the person extracted from the streaming video. This rectangualar plane is the edge of the visible and invisible part of the meant user (e.g due to the desktop)

Using this method, an off-line or on-line management system can easily decide where a 3-dimensional user visualization will be placed or seated. As such, a virtual meeting room can easily be created in a virtual environment where participants can be seated around the same virtual table where the management system allows for fixed positioning of the participants around the table.

In an other embodiment, the users are able to navigate the full 3-dimensional user visualization through the virtual environment. As such, people, visualized as full 3-dimensional user visualization, will be able to visit virtual locations like museums or social places and see the live images of the other persons.

In a further embodiment, the system is able to generate virtual views of the user from a multi-camera system by using viewpoint interpolation where the Viewpoint interpolation is the process of creating an virtual representation of the user based on the images of the left and right camera. This technique is then used to create a virtual texture map that can be wrapped around our genereated 3D model.

In still a further embodiment, only the head of the person is captured, converted into a model and visualized inside a special model, further referred to as Face- of F-Host, that acts as the head of the 3-dimensional host visualization e.g being a space-suit. The 3-dimensional user host visualization could e.g. look like the head part of an astronaut wearing a space suit, the head part of a monnik wearing a cap, or the head part of a some person wearing a sharp. Such system allows the user to look around by turning the avatar or by turning the avatar's head using an input device. Given enough screen estate and additional logic, a head tracking system can be used to move the head of the F-Host along with the head direction of the user.

It is to be noted that, although this embodiment is described for a client-server solution, alternative networks like a peer-to-peer network solution or any mix of these kind of networks may be applicable as well.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is merely made by way of example and not as a limitation on the scope of the invention, as defined in the appended claims.

1. Method for visualizing a user of a virtual environment in said virtual environment, said method comprising the step of generating a partial real-time 3-Dimensional Model of said user, wherein said method further comprises the step of generating a full 3-dimensional user visualization by coupling said 3-dimensional user visualization with a 3-dimensional host visualization.

2. Method for visualizing a user according to claim 1, wherein said coupling is performed in such way that said user visualization partly is covered by said host visualization.

3. System for visualizing a user of a virtual environment in said virtual environment determining, said system comprising a 3-dimensional model generating part, adapted to generate a partial real-time 3-Dimensional Model of said user, wherein said system further comprises a visualization parenting part, adapted generate a full 3-dimensional user visualization by coupling said 3-dimensional user visualization with a 3-dimensional host visualization.

4. System for visualizing a user of a virtual environment according to claim 3, wherein said visualization parenting part is further adapted to perform said coupling in such way that said user visualization partly is covered by said host visualization.

5. User Visualization processing device (UVPD) for use in a System for visualizing a user of a virtual environment according to claim 4, wherein said User Visualization processing device (UVPD) comprises a 3-dimensional model generating part, adapted to generate a partial real-time 3-Dimensional Model of said user, wherein said system further comprises a visualization parenting part, adapted generate a full 3-dimensional user visualization by coupling said 3-dimensional user visualization with a 3-dimensional host visualization.

6. User Visualization processing device according to claim 5, wherein said visualization parenting part, is further adapted to perform said coupling in such way that said user visualization partly is covered by said host visualization.

7. Module including said processing device according to claim 6.
